(19) United States
(12) Patent Application Publication
(10) Pub. No.: US 2013/0231231 A1
(43) Pub. Date: Sep. 5, 2013

(54) ROLLER, APPARATUS AND METHOD FOR MANUFACTURING SAME

(71) Applicant: CHIA-LING HSU, Tu-Cheng (TW)

(72) Inventor: CHIA-LING HSU, Tu-Cheng (TW)

(73) Assignee: HON HAI PRECISION INDUSTRY CO., LTD., Tu-Cheng (TW)

(21) Appl. No.: 13/592,364

(22) Filed: Aug. 23, 2012

(30) Foreign Application Priority Data
Mar. 2, 2012 (TW) 101107107

(51) Int. Cl. B29C 59/04; B28B 17/02

(52) U.S. Cl. 492/30; 425/112; 264/162

(57) ABSTRACT

A roller includes a cylindrical main body and a seamless ring-shaped resin film. The main body has a circumferential surface having a plurality of teeth. The resin film is coated on the circumstance surface and has a rolling surface opposite to the main body. The resin film defines impression patterns.

### BACKGROUND

1. Technical Field

The present disclosure relates to a roller, an apparatus and a method for manufacturing the roller.

2. Description of Related Art

Optical films define a number of micro structures. One method for forming the micro structures is a roll forming process using a metal roller. A circumference of the metal roller has impression patterns coupled with the micro structures. The impression pattern is formed by a laser knife. However, the roller of the roll forming process has a relatively low forming efficiency, and has a relatively high cost.

Therefore, it is desirable to provide a roller, an apparatus and a method for manufacturing the roller that can overcome the above-mentioned limitations.

### BRIEF DESCRIPTION OF THE DRAWINGS

Many aspects of the embodiments should be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic view of a roller, according to a first exemplary embodiment.

FIG. 2 is a schematic view of an apparatus for manufacturing a roller, according to a second exemplary embodiment.

FIG. 3 is a flow chart of a method for manufacturing a roller, according to a third exemplary embodiment.

FIG. 4 is a schematic view of an apparatus for manufacturing a roller, according to a fourth exemplary embodiment.

FIG. 5 is a flow chart of a method for manufacturing a roller, according to a fifth exemplary embodiment.

### DETAILED DESCRIPTION

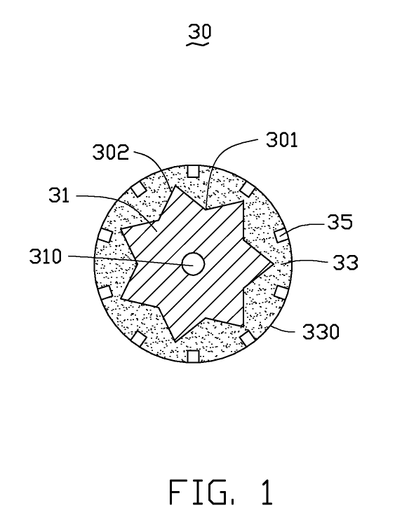

Referring to FIG. 1, a first exemplary embodiment of a roller 100 is used for manufacturing an optical film (not shown), and includes a cylindrical main body 31 and a seamless ring-shaped resin film 33 coated on a circumferential surface 301 of the main body 31.

The main body 31 is made of stainless steel or other metals. The circumferential surface 301 has a number of teeth 302 to increase the adhesive potential of the resin film 33 thereon. In the first embodiment, the teeth 302 are the same as each other and are evenly distributed on the circumferential surface 301 making the main body 31 to be gear-shaped. Each of the teeth 302 is substantially triangle-shaped. A highest point of each teeth 302 is about 1 centimeter (cm) to 2 cm in height with respect to the circumferential surface 301. The main body 31 defines a fixing hole 310 at the center thereof. In other embodiments, the fixing hole 310 can be omitted.

The resin film 33 is made of polymer resin having the molecular chain with fluorine element, such as ethylene tetrafluoroethylene (ETFE) or poly tetrafluoroethylene (PTFE). Therefore, the optical films are easily separated from the resin film 20, and the quality of the optical films can be greatly improved.

The resin film 33 has a cylindrical-shaped rolling surface 330 opposite to the main body 31, and defines a number of impression patterns 35 coupled with the micro structures of optical films. In the first embodiment, the impression patterns 35 are micro-grooves uniformly distributed on the rolling surface 330. The thickness of the resin film 33 between the rolling surface 330 and the circumferential surface 301 is about 1.5 cm to about 2.5 cm.

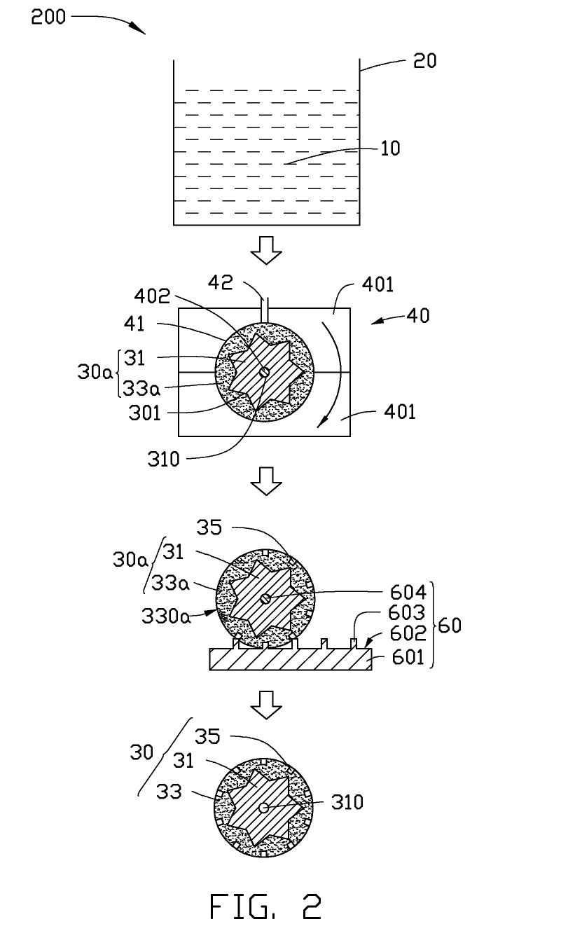

Referring to FIG. 2, a second exemplary embodiment of an apparatus 200 for manufacturing the roller 100 includes a heating device 20, a molding device 40, and a processing device 60.

The heating device 20 melts a polymer resin 10 at a first predetermined temperature. The polymer resin 10 is made of polymer resin having the molecular chain with fluorine element. In the second embodiment, the polymer resin 10 is made of PTFE, and the first predetermined temperature is about 340 Celsius degrees (° C.).

The molding device 40 molds a preprocessed resin film 33a on the circumstance surface 301 to form a preprocessed roller 30a. The molding device 40 has two molding sheets 401 contacting with each other. The two molding sheets 401 cooperatively define a cylindrical molding cavity 41. The molding device 40 further has an injection port 42 communicating with the molding cavity 41 and a rotating element 402 received in the molding cavity 41. The main body 31 is received in the molding cavity 41 and can be driven by the rotating element 402 to rotate. In this embodiment, the rotating element 402 is a rotating shaft fit with and extending through the fixing hole 310.

When the main body 31 rotates, the melted polymer resin 10 is poured into the molding cavity 41 through the injection port 42 until the molding cavity 41 is filled with the melted polymer resin 10. When the melted polymer resin 10 is cooled to be half-solid or solid, a preprocessed resin film 33a coated on the main body 31 and the preprocessed roller 30a is obtained. Then the two molding sheets 401 are separated to take out the preprocessed roller 30a from the molding cavity 41. In the second embodiment, the injection port 42 is defined on one of the two molding sheets 401.

The processing device 60 forms the impression patterns 35 on the preprocessed resin film 33a to obtain the roller 30. The processing device 60 includes a molding plate 601 and a driving element 604. The molding plate 601 has a plane-shaped molding surface 602 evenly distributing a number of molding patterns 603. In the second embodiment, the molding patterns 603 are micro-protrusions. The driving element 604 is used for driving the preprocessed roller 30a to roll on the molding surface 602 to form the impression patterns 35 on the processed resin film 33a. In this embodiment, the driving element 604 is a rotating shaft fit with and extending through the fixing hole 310.

In other embodiments, if the melted polymer resin 10 is cooled to be solid before being removed from the molding cavity 41, the solid polymer resin 10 can be heated again to be half-solid, and thus the impression patterns 35 can be easily formed.

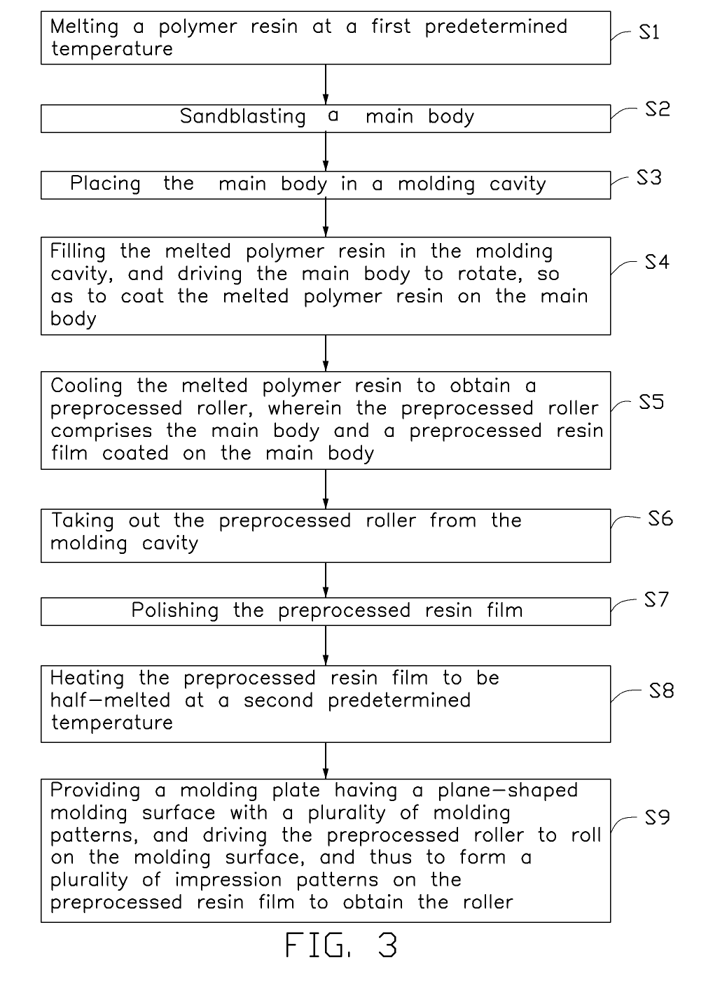

Also referring to FIG. 3, a third exemplary embodiment of a method for manufacturing the roller 100 using the apparatus 200 includes the following steps.

In step S1, the polymer resin 10 is provided, and is heated to be melted at a first predetermined temperature by the heating device 20. In the third embodiment, the polymer resin 10 is made of PTFE, and the first predetermined temperature is about 340° C.

In step S2, the cylindrical main body 31 is provided, and is sandblasted to be rough to enforce the adhesive potential of the melted polymer resin 10 thereon.

In step S3, the main body 31 is placed in the molding cavity 41.

In step S4, the main body 31 is driven to be rotate, and the melted polymer resin 10 is poured into the molding cavity 41 through the injection port 42 until the molding cavity 41 is filled.

In step S5, the melted polymer resin 10 is cooled to obtain the preprocessed roller 30a. And the preprocessed roller 30a includes the main body 31 and the preprocessed film 33a. The preprocessed film 33a has a preprocessed rolling surface 330a opposite to the main body 31.

In step S6, the preprocessed roller 30a is taken out from the molding cavity 41.

In step S7, the preprocessed rolling surface 330a is polished.

In step S8, the preprocessed resin film 33a is heated to be half-melted at a second predetermined temperature (such as 250° C.˜260° C.).

In step S9, the molding plate 601 having a plane-shaped molding surface 602 with a number of molding patterns 603 is provided, and the preprocessed roller 30a is driven to roll on the molding surface 602, and thus to form a number of impression patterns 35 on the preprocessed resin film 33 to obtain the roller 30.

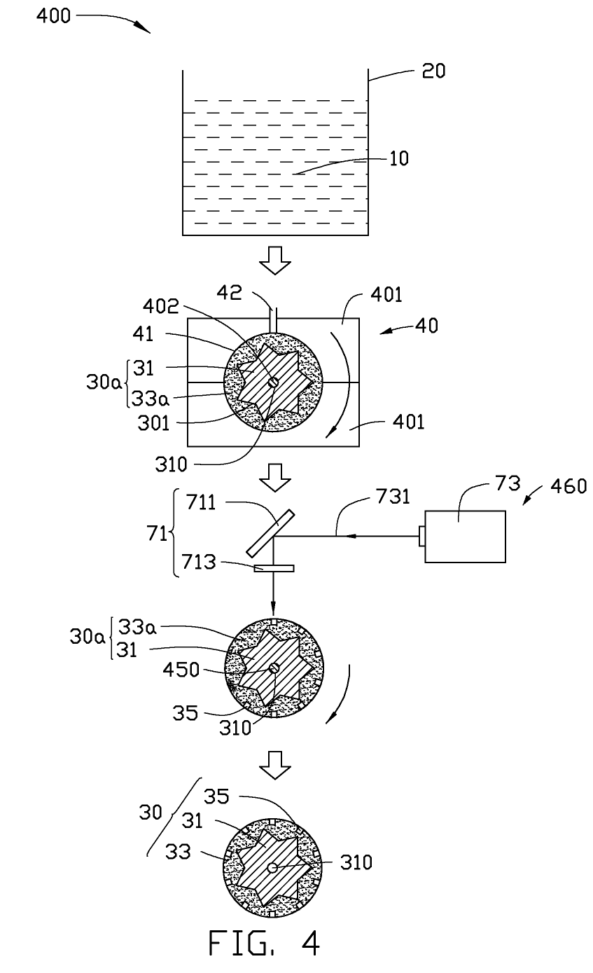

Referring to FIG. 4, an apparatus 400 for manufacturing the roller 100 according to a fourth exemplary embodiment is shown. The difference between the apparatus 400 and the apparatus 200 is that the processing device 460 is a laser device, and includes a driving element 450, an optical guiding system 71, and a laser emitter 73. The preprocessed roller 30a is positioned on the driving element 450, and can be rotated by the driving element 450. In this embodiment, the driving element 450 is a rotating shaft fit with and extending through the fixing hole 310. The laser emitter 73 is used for emitting laser beams 731. The optical guiding system 71 guides the laser beams 731 to the processed resin film 33a, and includes a reflector 711 and a converging lens 713. The reflector 711 reflects the laser beams 731 to the converging lens 713. The converging lens 713 is aligned with the processed resin film 33a and converges the laser beams 731 to the processed resin film 33a.

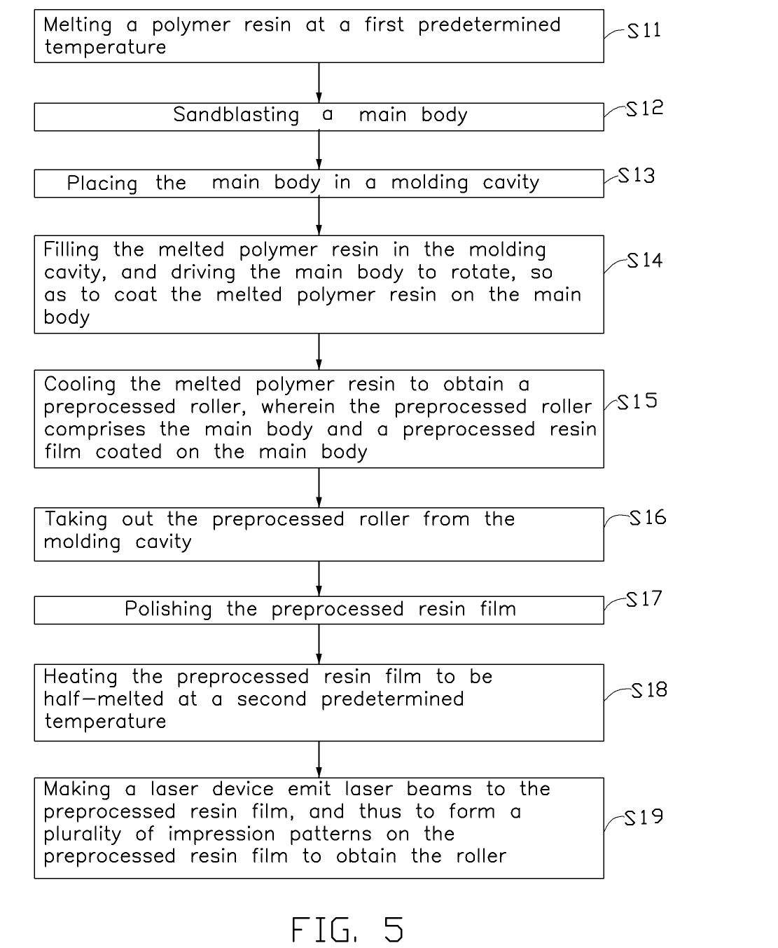

Also referring to FIG. 5, a method for manufacturing the roller 30 according to a fifth exemplary embodiment is shown, and includes the following steps.

The steps S11-S18 are substantially the same as the steps S1-S8 respectively.

The step S19 includes the following sub-steps: the laser device 460 emits laser beams to the preprocessed resin film 33a; the laser device 460 is turned off; the preprocessed roller 30a is rotated a predetermined angle; and the laser device 460 is turned on and emits the laser beams to the preprocessed resin film 33a again. The above steps are repeated until the molding patterns 35 are formed on the preprocessed resin film 33a, and thus the roller 30 is obtained.

By employing the apparatus and the method, the seamless ring-shaped preprocessed resin film 33a can be directly formed on the circumferential surface 301 of the main body 31 using the molding device, and then the impression patterns 35 can be directly formed on the preprocessed resin film 33a to from the resin film 33, and the roller is thus obtained. Therefore, the manufacturing efficiency will be improved.

The above particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A roller, comprising:
a cylindrical main body having a circumferential surface, the circumstance surface having a plurality of teeth; and
a seamless resin film coated on the circumstance surface and having a rolling surface opposite to the main body, the rolling surface defining a plurality of impression patterns.

2. The roller of claim 1, wherein the teeth are the same as each other and are evenly distributed on the circumferential surface.

3. The roller of claim 2, wherein each of the teeth is substantially triangle-shaped, and a highest point of each of the teeth is about 1 centimeter to 2 centimeters in height with respect to the circumferential surface.

4. The roller of claim 1, wherein the resin film is made of polymer resin having the molecular chain with fluorine element.

5. The roller of claim 1, wherein the rein film is made of ethylene tetrafluoroethylene or poly tetrafluoroethylene.

6. An apparatus for manufacturing a roller, comprising:
a heating device configured for heating a polymer resin to be melted;
a molding device defining a cylindrical molding cavity for receiving a main body, the molding device having an inject port communicated with the molding cavity, the inject port configured for allowing the melted polymer resin to enter the molding cavity through the inject port to coat on the main body, thus to obtain a processed roller comprising the main body and a processed resin film coated on the main body; and
a processing device configured for processing a plurality of impression patterns on the processed resin film, thus to obtain the roller.

7. The apparatus of claim 6, wherein the molding device comprises two molding sheets contacting with each other, the molding cavity is defined by the two molding sheets, the two molding sheets are capable of being separated from each other to take out the preprocessed roller, the inject port is defined on one of the two molding sheets.

8. The apparatus of claim 6, wherein the molding device comprises a rotating element, the rotating element is configured for rotating the main body when the melted polymer resin is poured into the molding cavity through the inject port.

9. The apparatus of claim 6, wherein the processing device comprises a molding plate and a driving element, the molding plate has a plane-shaped molding surface defining a plurality of molding patterns, the driving element is configured for driving the preprocessed roller to roll on the molding surface.

10. The apparatus of claim 6, wherein the processing device comprises a laser device and a driving element, the laser device comprises a laser emitter for emitting laser beams to the preprocessed resin film, the driving element is configured for driving the preprocessed roller to rotate a predetermined angle.

11. The apparatus of claim 10, wherein the laser device further comprises an optical guiding system, the optical guiding system comprises a reflector for transmitting the laser beams to the preprocessed resin film.

12. The apparatus of claim 11, wherein the optical guiding system further comprises a converging lens for converging the laser beams from the reflector to the preprocessed resin film.

13. A method for manufacturing a roller, comprising:
melting a polymer resin at a first predetermined temperature;
rotating a main body in a molding cavity;
filling the melted polymer resin in the molding cavity, so as to coat the melted polymer resin on the main body;
cooling the melted polymer resin to obtain a preprocessed roller, the preprocessed roller comprising the main body and a preprocessed resin film coated on the main body;
taking out the preprocessed roller from the molding cavity; and
forming a plurality of impression patterns on the preprocessed resin film to obtain the roller.

14. The method of claim 13, comprising: sandblasting the main body before the step of rotating a main body in a molding cavity.

15. The method of claim 13, comprising: polishing the preprocessed resin film before the step of forming a plurality of impression patterns on the preprocessed roller.

16. The method of claim 13, comprising: heating the preprocessed resin film to be half-melted at a second predetermined temperature before the step of forming a plurality of impression patterns on the preprocessed roller.

17. The method of claim 16, wherein the polymer resin is made of poly tetrafluoroethylene, the first predetermined temperature is about 340° C., and the second predetermined temperature is about 250° C. to about 260° C.

18. The method of claim 13, wherein the step of forming a plurality of impression patterns on the preprocessed roller comprises: providing a molding plate having a plane-shaped molding surface with a plurality of molding patterns, and driving the preprocessed roller to roll on the molding surface.

19. The method of claim 13, wherein the step of forming a plurality of impression patterns on the preprocessed roller comprises:
activating a laser device to emit laser beams to the preprocessed resin film;
turning the laser device off;
rotating the preprocessed roller a predetermined angle; and
activating the laser device to emit the laser beams to the preprocessed resin film again.
